(19) United States
(12) Patent Application Publication
(10) Pub. No.: US 2025/0379308 A1
(43) Pub. Date: Dec. 11, 2025

(54) Fireproof Containment Modular Battery Tray

(71) Applicant: Toshiba International Corporation, Houston, TX (US)

(72) Inventors: Enrique Martinez, Cypress, TX (US); Jared Cobb, Katy, TX (US); Michael Alexander, Katy, TX (US)

(21) Appl. No.: 19/295,790

(22) Filed: Aug. 11, 2025

Related U.S. Application Data
(63) Continuation-in-part of application No. 18/736,742, filed on Jun. 7, 2024.

(51) Int. Cl. H01M 50/22; H01M 50/258; H01M 50/293; H01M 50/296; H01M 50/35; H01M 50/529

(52) U.S. Cl. CPC H01M 50/22; H01M 50/258; H01M 50/293; H01M 50/296; H01M 50/35; H01M 50/529

(57) ABSTRACT

The present disclosure relates to battery cabinets and other power or electronic apparatuses comprising batteries, more particularly, to a modular tray enclosure. The modular tray enclosure comprises a primary base, a first sidewall, a second sidewall, a back wall, and a top wall. Each of the aforementioned components can comprise fire-proof material. A modular tray is contained within the modular tray enclosure and configured to house at least one battery.

### CROSS REFERENCE TO RELATED APPLICATION

This application is a continuation-in-part application of U.S. application Ser. No. 18/736,742, filed on Jun. 7, 2024, which is incorporated herein by reference in its entirety.

### TECHNICAL FIELD

Embodiments of the present disclosure relate to battery cabinets and other power or electronic apparatuses comprising batteries, more particularly, to a modular tray configured to inhibit thermal runaway propagation by containing a fire within the modular tray.

### BACKGROUND

There are potential fire hazards associated with operation of electric vehicle batteries and/or battery energy storage systems. For example, thermal runaway can occur when there is an accelerating release of heat inside a battery cell due to a series of uncontrollable exothermic reactions manifesting as an exponential increase in the battery cell temperature. Thermal stability of the battery cell is lost when it can no longer dissipate heat as quickly as it is being generated. The energy released from a single failing battery cell during thermal runaway can raise the temperature of neighboring cells to drive them into thermal runaway, thus, causing the propagation of thermal runaway.

There is a need for an improved battery tray that can prevent or isolate fire propagation from module to module.

### BRIEF DESCRIPTION OF THE DRAWINGS

For a more complete understanding of the present disclosure and its features and advantages, reference is now made to the following description, taken in conjunction with the accompanying drawings, in which:

FIGS. 1A-1C illustrate an example modular tray, in accordance with an embodiment of the present disclosure;

FIG. 2 illustrates an assembled example of the modular tray of FIGS. 1A-1C, in accordance with an embodiment of the present disclosure;

FIG. 3 illustrates an example airflow through the modular tray of FIGS. 1A-1C, in accordance with an embodiment of the present disclosure;

FIGS. 4A-4C illustrate additional examples of a modular tray, in accordance with an embodiment of the present disclosure;

FIGS. 5A-5B illustrate another example modular tray and modular tray enclosure, in accordance with an embodiment of the present disclosure; and

FIG. 6 illustrates an example battery cabinet, in accordance with an embodiment of the present disclosure.

### DETAILED DESCRIPTION

Illustrative embodiments of the present disclosure are described in detail herein. In the interest of clarity, not all features of an actual implementation are described in this specification. It will of course be appreciated that in the development of any such actual embodiment, numerous implementation specific decisions must be made to achieve developers' specific goals, such as compliance with system related and business-related constraints, which will vary from one implementation to another. Moreover, it will be appreciated that such a development effort might be complex and time consuming but would nevertheless be a routine undertaking for those of ordinary skill in the art having the benefit of the present disclosure. Furthermore, in no way should the following examples be read to limit, or define, the scope of the disclosure.

The present disclosure relates to an apparatus, system, and/or method for inhibiting or isolating thermal runaway from propagating module to module (i.e., such as a modular tray). More specifically, the present disclosure provides a modular tray configured to contain a potential fire within itself and to prevent the fire from spreading. For example, there are standards associated with certain battery or energy storage systems, such as the Underwriters Laboratories (standards. Some UL standards relate to the testing of fire hazards associated with propagating thermal runaway within battery systems. To pass certain standards, a given system must meet certain testing requirements including: cell level test, module level test, unit level test, and/or installation level test. In embodiments, the present disclosure provides a modular tray configured to satisfy or pass certain standards. For example, the modular tray may be incorporated into a larger installation, and the modular tray, by itself, may satisfy or pass the module or unit level test of the UL fire test or other recognized safety certifications or standards. The modular tray may be configured to allow airflow through the modular tray to cool at least one battery and may comprise barrier walls to prevent a potential fire initiating from within to spread outwards.

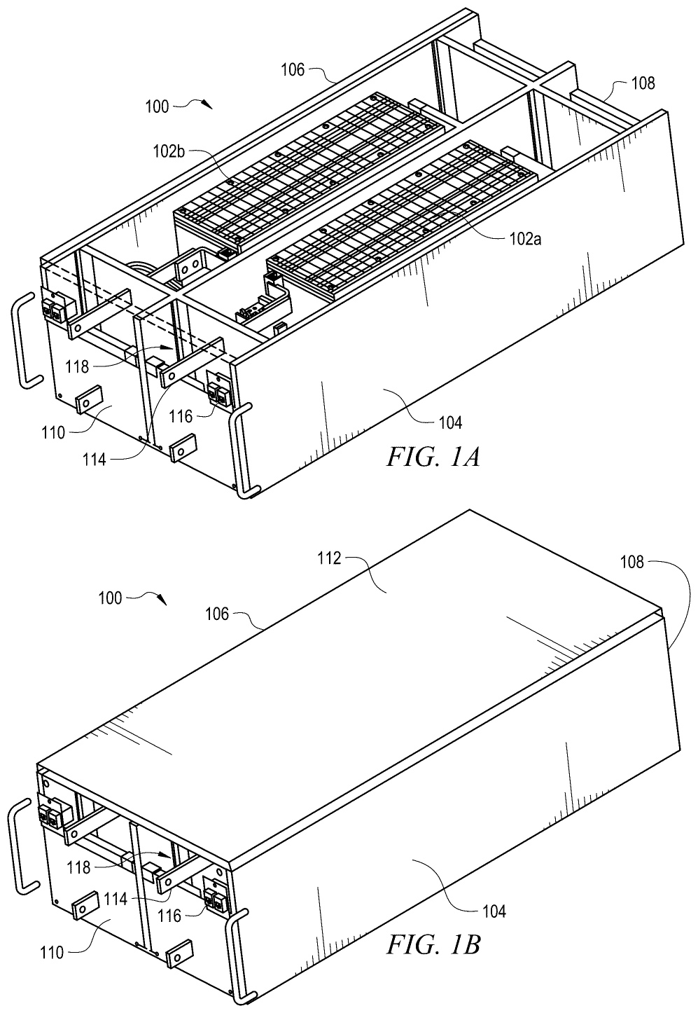

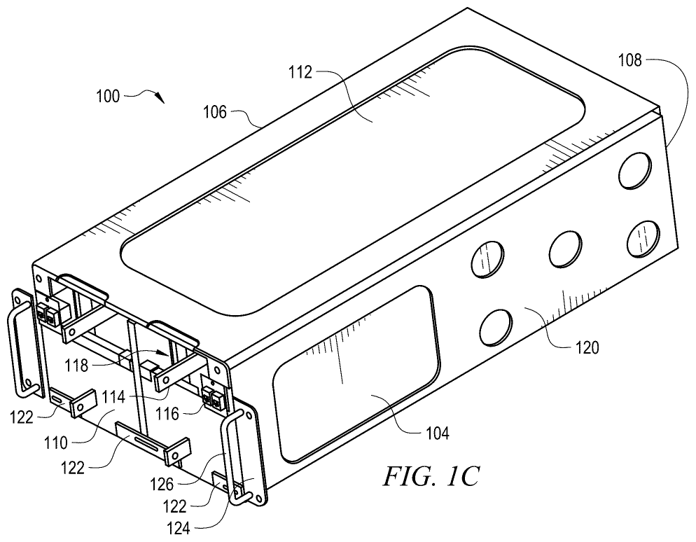

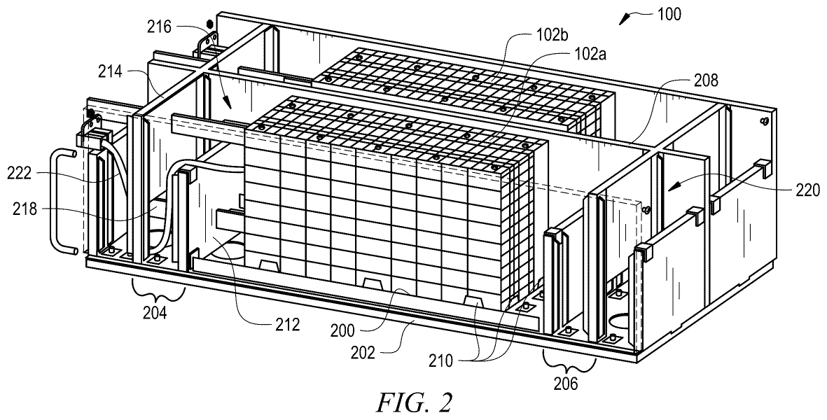

FIGS. 1A-1C illustrate an example of a modular tray 100. FIG. 1A illustrates a view showing an interior of the modular tray 100. FIG. 1B illustrates the modular tray 100 part-way through assembly. FIG. 1C illustrates a fully assembled modular tray 100. In embodiments, the modular tray 100 may be configured to contain at least one battery, such as a first battery 102a and a second battery 102b as seen in FIG. 1A. The first battery 102a and second battery 102b may be any suitable battery, such as a lithium-ion battery or a lithium-titanium-oxide battery. The modular tray 100 may be utilized in any suitable application requiring batteries, such as in an uninterruptible power supply (UPS). In embodiments, the modular tray 100 may be any suitable size, height, shape, and combinations thereof. The modular tray 100 may comprise any suitable materials. Without limitations, the modular tray 100 may comprise metals, nonmetals, polymers, composites, and combinations thereof. In one or more embodiments, the modular tray 100 may comprise a primary base (as best seen in FIG. 2), a first sidewall 104, a second sidewall 106, a back wall 108, a front wall 110, and a top wall 112. Both the first sidewall 104 and the second sidewall 106 may be coupled to the primary base and extend perpendicular to the primary base. As illustrated, the first sidewall 104 may be parallel to the second sidewall 106 and may be disposed at an opposite side of the primary base from the second sidewall 106. Similarly, both the back wall 108 and the front wall 110 may be coupled to the primary base and extend perpendicular to the primary base. Further, both the back wall 108 and front wall 110 may be perpendicular to the first and second sidewalls 104, 106. As shown, the front wall 110 may be disposed at an opposite side of the primary base relative to the back wall 108. In embodiments, the top wall 112, as best seen in FIGS. 1B and 1C, may be disposed on top of each of the first sidewall 104 and the second sidewall 106. The top wall 112 may be parallel to the primary base. Each one of the first sidewall 104, the second sidewall 106, the back wall 108, the front wall 110, and the top wall 112 may comprise a fire-proof material. Without limitations, the fire-proof material may include any fiber board or composites that use ceramic insulating material including Alumina or Magnesium oxide. In one or more embodiments, the fire-proof material may be Superwool® 1650SI HS board. The material or composite could utilize mica or vermiculite. The material could include any fiber, composite, or resin in conjunction with intumescent or cementitious coating, for example, the use of Novec in conjunction with Mica board. In embodiments, the fire-proof material may be any suitable material capable of maintaining structural integrity up to a threshold value, wherein the threshold value may be about 1000° F.

The modular tray 100 may further comprise one or more busbars 114 and one or more communication ports 116. The one or more busbars 114 may be electrically connected to at least one battery, such as the first battery 102a and second battery 102b, and extend outwardly away from the modular tray 100 to provide and/or receive power. For example, as illustrated, the one or more busbars 114 may extend through and past the front wall 110, but the modular tray 100 is not limited to such a configuration. In other examples, the one or more busbars 114 may extend through and past the first sidewall 104, second sidewall 106, back wall 108, and/or top wall 112. The one or more communication ports 116 may be disposed about the front wall 110. Similarly, the modular tray 100 is not limited to such a configuration, and the one or more communication ports 116 may be disposed about any suitable location along the modular tray 100. Without limitations, the one or more communication ports 116 may be a Registered Jack (RJ)-45 port, wherein the one or more communication ports 116 may be compatible with a RJ-45 cable that may be shielded and/or unshielded. In embodiments, the one or more communications ports 116 may be used for tray-to-tray communication, for communication with a PCB, as service ports, and combinations thereof.

In embodiments, both the back wall 108 and the front wall 110 may comprise a height that is less than a height of the first sidewall 104 and the second sidewall 106. The heights of the back wall 108 and front wall 110 may be the same or different. An inlet 118 may be defined between the front wall 110, top wall 112, first sidewall 104, and second sidewall 106, wherein the inlet 118 may be configured to direct an airflow into the modular tray 100. Similarly, an outlet (as best seen in FIG. 2) may be defined between the back wall 108, top wall 112, first sidewall 104, and second sidewall 106, wherein the outlet may be configured to direct the airflow out of the modular tray 100.

With reference to FIG. 1C, the modular tray 100 may further comprise a protective housing 120 disposed around at least a portion of the top wall 112, the first sidewall 104, the second sidewall 106, the primary base, or a combination thereof. The protective housing 120 may be any suitable size, height, shape, and combinations thereof. The protective housing 120 may comprise any suitable materials. In embodiments, the protective housing 120 may comprise a material different from the walls and base of the modular tray 100. For example, the protective housing 120 may comprise sheet metal or another suitable metal while the first sidewall 104, the second sidewall 106, the back wall 108, the front wall 110, and the top wall 112 comprise a fire-proof material. In another example, the protective housing 120 may comprise stainless steel, aluminum, or any other suitable ferrous material. In one or more embodiments, the protective housing 120 may completely cover at least one of the top wall 112, the first sidewall 104, the second sidewall 106, the primary base, or a combination thereof. In other embodiments, there may be holes or sections defined therein.

The protective housing 120 may comprise one or more flanges 122 extending over at least a portion of the front wall 110 and/or the back wall 108. The one or more flanges 122 may be configured to secure the front wall 110 and/or the back wall 108 to the primary base. The protective housing 120 may further comprise a side flange 124 extending perpendicularly away from the first sidewall 104 or the second sidewall 106. In embodiments, there may be a side flange 124 associated with both the first sidewall 104 and the second sidewall 106. The side flange 124 may be disposed about or in-line with the front wall 110. There may be a handle 126 disposed on the side flange 124 configured to provide translation to the modular tray 100. For example, the modular tray 100 may be disposed within a cabinet. An operator may grasp the handle 126 and provide a force to move the modular tray 100 relative to the cabinet.

FIG. 2 illustrates an isometric, partial cross-sectional view of the modular tray 100. With reference to this specific figure, the top wall 112 is not presently shown in order to depict the interior. FIG. 2 shows additional components of the modular tray 100. In one or more embodiments, the modular tray 100 may further comprise the primary base 200, a secondary base 202, a first set of barrier walls 204, a second set of barrier walls 206, and a partition wall 208. In embodiments, the primary base 200 may be a portion of or formed from the protective housing 120 (referring to FIG. 1C). In other embodiments, the primary base 200 may be a separate component comprising a similar material to the protective housing 120. The primary base 200 may be configured to house and secure certain components within the modular tray 100. The primary base 200 may comprise a set of guideposts 210 extending perpendicularly away from said primary base 200. The set of guideposts 210 may be disposed at determined positions to define an area for receiving at least one battery, such as the first battery 102a. For example, the first battery 102a may be disposed within the defined area and may be secured to the primary base 200 by the set of guideposts 210. The set of guideposts 210 may be any suitable size, height, shape, and combinations thereof. In embodiments, each one of the set of guideposts 210 may comprise the same dimensions. In other embodiments, the set of guideposts 210 may differ in any one of size, height, and/or shape.

The primary base 200 may be disposed on top of and aligned with the secondary base 202. Like each one of the first sidewall 104 (referring to FIGS. 1A-1C), the second sidewall 106 (referring to FIGS. 1A-1C), the back wall 108 (referring to FIGS. 1A-1C), the front wall 110 (referring to FIGS. 1A-1C), and the top wall 112 (referring to FIGS. 1A-1C), the secondary base 202 may comprise a fire-proof material. In embodiments, the primary base 200 and the secondary base 202 may comprise approximately equivalent lengths and widths. In other embodiments, one of the primary base 200 and secondary base 202 may comprise a larger dimension than the remaining one.

As illustrated, the first set of barrier walls 204 may be disposed between the front wall 110 and the first battery 102a, and the second set of barrier walls 206 may be disposed between the back wall 108 and the first battery 102a. Each of the first set of barrier walls 204 and second set of barrier walls 206 may comprise a first barrier wall 212 and a second barrier wall 214. The first barrier wall 212 may be disposed on the primary base 200 and extends perpendicular to the primary base 200. Similar to the front wall 110 and back wall 108, the first barrier wall 212 may comprise a height that is less than the height of the first sidewall 104 and the second sidewall 106. In embodiments, the height of the first barrier wall 212 may be the same or different from that of the front wall 110 and back wall 108. There may be a first opening 216 defined between the top end of the first barrier wall 212 and the top wall 112. In embodiments, the first barrier wall 212 may be disposed between the first battery 102a and the second barrier wall 214. The second barrier wall 214 may be disposed against the top wall 112 and extend perpendicularly downwards from the top wall 112 to the primary base 200. There may be a second opening 218 defined between the bottom end of the second barrier wall 214 and the primary base 200. In alternate embodiments, the second barrier wall 214 may be disposed between the first battery 102a and the first barrier wall 212. In additional embodiments, the first set of barrier walls 204, second set of barrier walls 206, or both may comprise a singular one of the first barrier wall 212 and second barrier wall 214 (i.e., just the first barrier wall 212 or second barrier wall 214). Alternatively, the first barrier wall 212 may be disposed against the top wall 112 and extend perpendicularly downwards from the top wall 112 to the primary base 200, wherein the first opening 216 may be defined between the bottom end of the first barrier wall 212 and the primary base 200. Further in these alternate embodiments, the second barrier wall 214 may be disposed on the primary base 200 and extend perpendicular from the primary base 200 to the top wall 112, wherein the second opening 216 may be defined between the top end of the second barrier wall 214 and the top wall 112.

As illustrated, the first barrier wall 212 and second barrier wall 214 may extend from the primary base 200 and top wall 112, respectively, however, the present disclosure is not limited to such a configuration. For example, in one or more embodiments, the first barrier wall 212 and/or second barrier wall 214 may be disposed along and extend from a sidewall, such as the first sidewall 104 or the second sidewall 106. In these embodiments, the first opening 216 and/or second opening 218 may be defined between said respective sidewall and an end of the corresponding first barrier wall 212 and/or second barrier wall 214, wherein that end of the corresponding first barrier wall 212 and/or second barrier wall 214 may be parallel to the sidewall. In further embodiments, the first barrier wall 212 and/or second barrier wall 214 may extend fully to the top wall 112 and primary base, respectively, and may have a width approximately equal to a distance between the first sidewall 104 and second sidewall 106 (i.e., effectively compartmentalizing the interior of the modular tray 100). In these embodiments, the first opening 216 and/or second opening 218 may be defined at any suitable location along the first barrier wall 212 and/or second barrier wall 214, respectively. The first opening 216 and/or second opening 218 may comprise any suitable shape configured to facilitate airflow. Without limitations, such a shape may be square, rectangular, triangular, circular, polygonal, and any combination thereof.

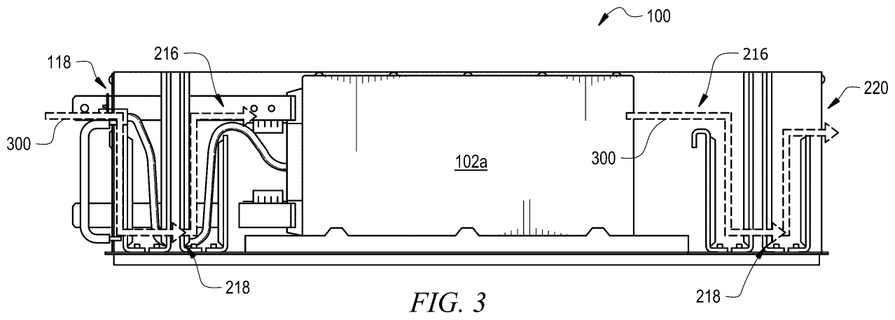

In embodiments, both the first opening 216 and the second opening 218 may be configured to facilitate an airflow through the modular tray 100, as discussed further below with reference to FIG. 3. For example, an airflow may be introduced through the inlet 118 (referring to FIGS. 1A-1C), flow through the first opening 216 and second opening 218 of both the first set of barrier walls 204 and second set of barrier walls 206, and out through an outlet 220 defined between the back wall 108, top wall 112, first sidewall 104, and second sidewall 106. While airflow may be permitted to flow through the modular tray 100, the configuration of the modular tray 100 may prevent a fire from within to escape, via the first and second set of barrier walls 204, 206. In addition, the configuration of the modular tray 100 may provide for one or more gases to escape and be released from the interior of the modular tray 100. In further embodiments, at least one cable 222 may be disposed through the first opening 216 and second opening 218 associated with the first set of barrier walls 204 to couple the first battery 102a to the one or more communication ports 116 (referring to FIGS. 1A-1C). In embodiments, the cable 222 may communicatively couple the one or more communication ports 116 to the first battery 102a.

The modular tray 100 may further comprise the partition wall 208. The partition wall 208 may be disposed between and parallel to the first sidewall 104 and second sidewall 106. The partition wall 208 may further be coupled to both the front wall 110 and the back wall 108. In embodiments, the partition wall 208 may be configured to divide the interior of the modular tray 100 into two separate compartments each capable of housing a battery, such as the first battery 102a and second battery 102b, respectively. In these embodiments, the modular tray 100 may comprise twice as many components of at least some of the previously described components, to be associated with each separate compartment. For example, there may be a second set of guideposts disposed on an opposite side of the partition wall 208 from the set of guideposts 210, wherein the second set of guideposts may define a second area for receiving and securing the second battery 102b. While the illustrated embodiment provides a singular partition wall 208, there may be one or more partition walls 208 disposed within the modular tray 100 to further sub-divide the interior of the modular tray 100 to accommodate additional batteries.

FIG. 3 illustrates an example airflow 300 during operation of the modular tray 100. In one or more embodiments, the airflow 300 may be introduced into the modular tray 100 through the inlet 118. The airflow 300 may then be directed to flow through the second opening 218 and subsequently through the first opening 216, both associated with the first set of barrier walls 204 (referring to FIG. 2), in order to reach the at least one battery, such as the first battery 102a. Heat transfer may occur between the airflow 300 and the first battery 102a in order to cool the first battery 102a. The airflow 300 may then be directed to flow through the first opening 216 and subsequently the second opening 218, both associated with the second set of barrier walls 206 (referring to FIG. 2), in order to exit the modular tray 100 through the outlet 220. In embodiments, the airflow 300 may be discharged through the outlet 220 at a temperature greater than that at which the airflow 300 was introduced into the modular tray 100 through the inlet 118.

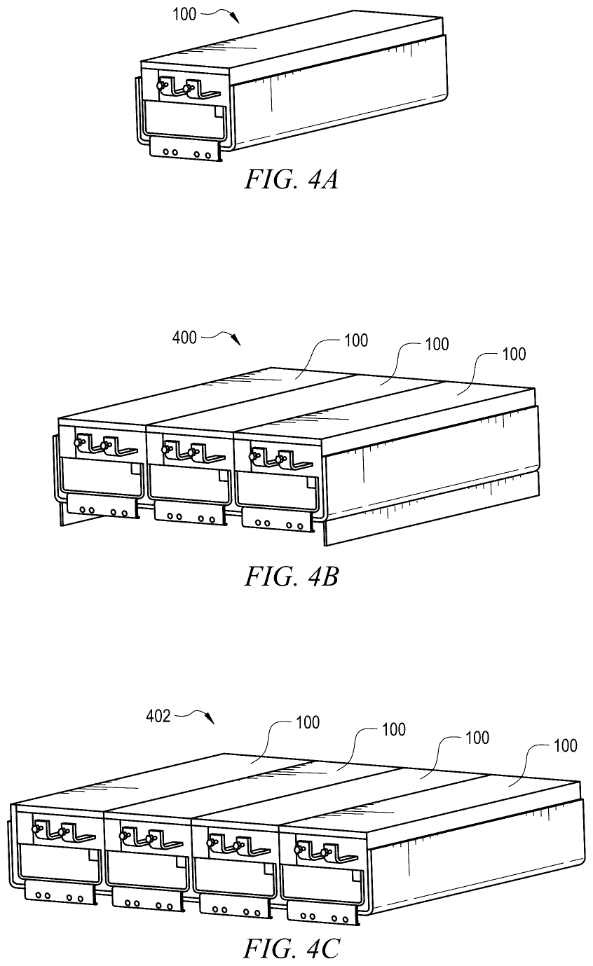

FIGS. 4A-4C illustrate additional examples of a modular tray. FIG. 4A illustrates the modular tray 100. FIG. 4B illustrates another example of a modular tray 400. FIG. 4C illustrates another example of a modular tray 402. The present disclosure provides a tray being modular that may prevent or isolate thermal runaway from propagating module to module. For example, the modular tray 100 illustrated in FIG. 4A has been previously described above. However, the configuration of modular tray 100 is not limited. For example, modular tray 100 may be configured to contain two batteries, such as the first battery 102a (referring to FIG. 1A) and the second battery 102b (referring to FIG. 1A). With reference to FIG. 4B, the modular tray 400 may be configured to contain more batteries, such as up to six batteries. With reference further to FIG. 4C, the modular tray 402 may be configured to contain more batteries than modular tray 400, such as up to eight batteries. Without limitations, the configuration of the modular tray 100 may be customizable or adaptive to accommodate any suitable number of batteries. For example, multiple modular trays 100 may be combined to produce the modular tray 400 or modular tray 402. A plurality of modular trays 100 may be combined and arranged in a row or in a column to produce the modular tray 400 or modular tray 402, depending on the requirements of the receiving receptacle.

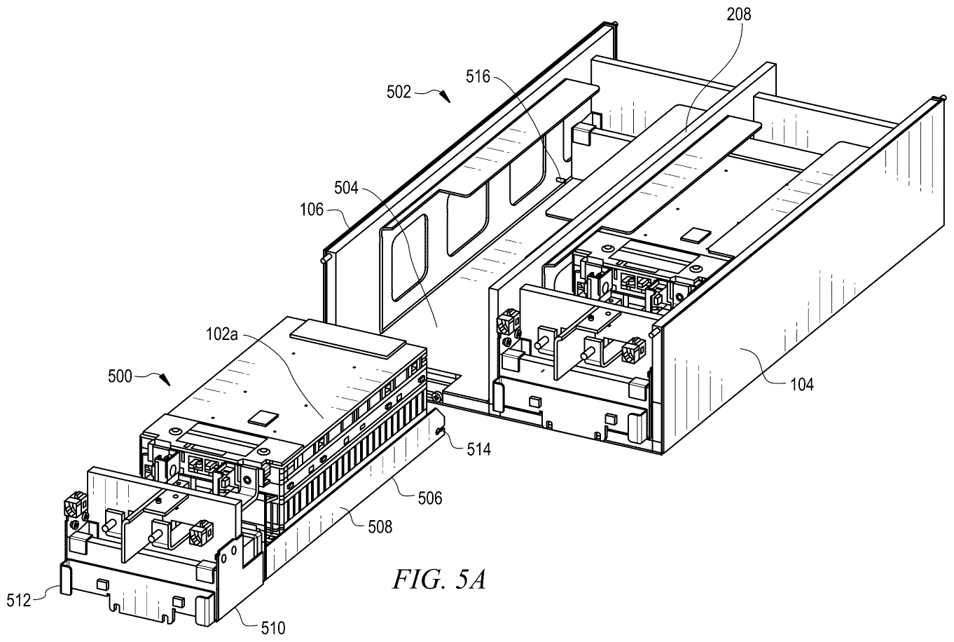

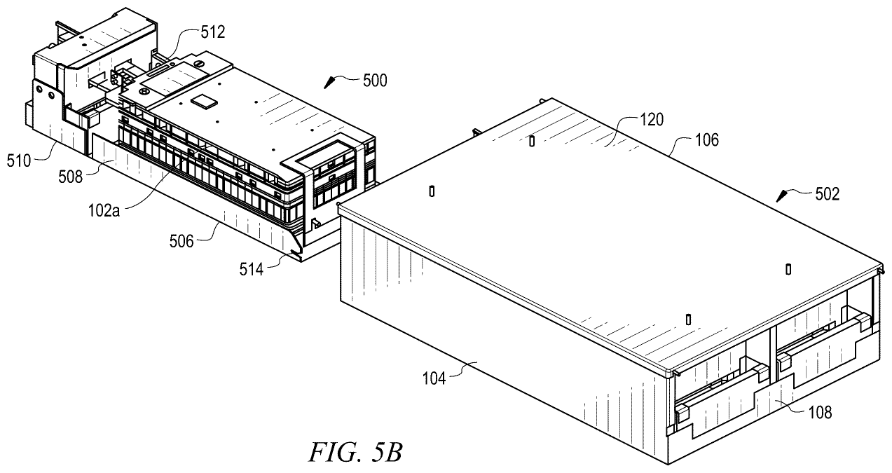

FIGS. 5A-5B illustrate isometric views of a modular tray 500 housed in a modular tray enclosure 502. FIG. 5A illustrates a front, isometric view without the top wall 112 (not shown) or protective housing 120 (not shown) to illustrate the interior of the modular tray 500 and modular tray enclosure 502. FIG. 5B illustrated a back, isometric view with the protective housing 120 disposed over the top wall 112 (not shown). In one or more embodiments, the modular tray 500 and modular tray enclosure may collectively comprise the same or similar structure and features of the modular tray 100 described above with reference to FIGS. 1A-4C. With reference to FIGS. 5A-5B, certain components previously described may correspond to the modular tray 500 and the remaining previously described components may correspond to the modular tray enclosure 502. For example, the modular tray enclosure 502 may comprise at least a primary base 504, the first sidewall 104, the second sidewall 106, the top wall 112, the back wall 108, and the partition wall 208, wherein the partition wall 208 may define a first space configured to house the modular tray 500 and a second space configured to house a second modular tray 500. As illustrated, the protective housing 120 may be disposed at least partially over the first sidewall 104, the second sidewall 106, the top wall 112, the back wall 108, and any combinations thereof. The primary base 504 may comprise a portion of the protective housing 120 disposed on the bottom of the modular tray enclosure 502. In other embodiments, the primary base 504 may be a layer of material disposed underneath the portion of the protective housing 120 on the bottom of the modular tray enclosure 502.

The modular tray 500 may be configured to secure and house at least one battery, such as the first battery 102a. The modular tray 500 may comprise the front wall 110 and the first set of barrier walls 204. The modular tray 500 may comprise a first base 506. The first base 506 may correspond to the primary base 200 (referring to FIG. 2) or the secondary base 202 (referring to FIG. 2), as described above. In embodiments, the first base 506 may be a portion of or formed from the protective housing 120. In other embodiments, the first base 506 may be a separate component comprising a similar material to the protective housing 120. In embodiments, there may be a vertical flange 508 disposed on a first side 510 and a second side 512 (not shown) of the first base 506. In embodiments, each of the vertical flanges 508 may comprise an opening 514 configured to receive a pin 516. Each pin 516 may be disposed in the interior of the modular tray enclosure 502. For example, a first one of the pins 516 may extend from the first sidewall 104 at least partially towards the second sidewall 106 and a second one of the pins 516 may extend from the second sidewall 106 at least partially towards the first sidewall 104.

In embodiments, the modular tray 500 may be configured to be secured to and housed within the modular tray enclosure 502. For example, in a first position, the modular tray 500 may be completely housed within the modular tray enclosure 502. In the first position, the first base 506 may be disposed on top of and aligned with the primary base 504 of the modular tray enclosure 502. Further, the pins 516 may be received by and located within the openings 514 of the vertical flanges 508. The modular tray 500 may slide outwards from the first position to a second, partially open position in reference to the modular tray enclosure 502. An operator may slide the modular tray 500 between first and second positions for maintenance, to replace the battery (such as the first battery 102a), and for any other suitable operations.

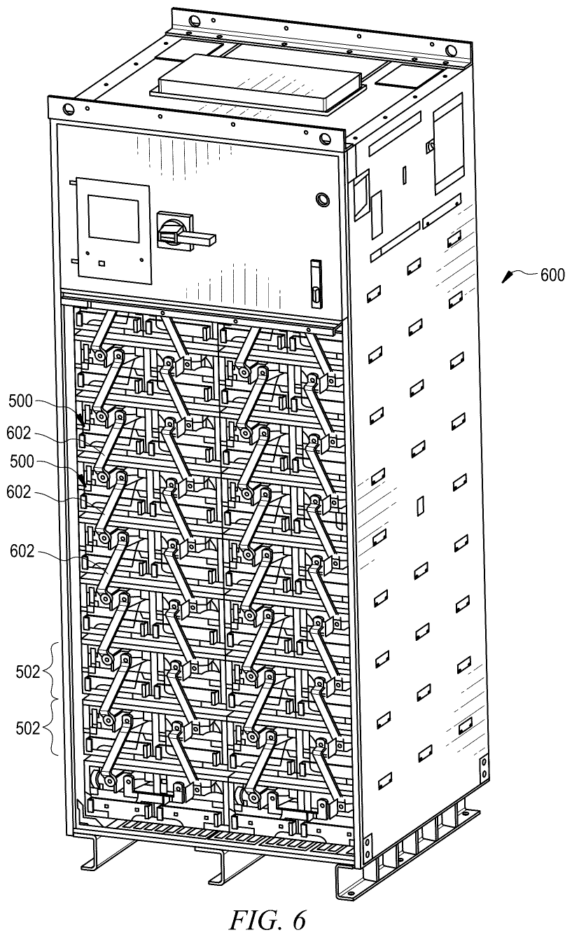

FIG. 6 illustrates an isometric view of a battery cabinet 600. The battery cabinet may comprise a plurality of the modular tray enclosures 502 and a plurality of modular trays 500 housed in each of the plurality of modular tray enclosures 502. As illustrated, there may be one or more busbars 602 electrically coupling each one of the batteries, such as the first or second batteries 102a, 102b of the plurality of modular trays 500 together. With reference to FIGS. 5A-5B, the operator may be able to slide each one of the plurality of modular trays 500 between first and second positions in each of their respective modular tray enclosures 502 within the battery cabinet 600. Although the disclosure and its advantages have been described in detail, it should be understood that various changes, substitutions and alterations can be made herein without departing from the spirit and scope of the disclosure as defined by the following claims.

What is claimed is:

1. A modular tray enclosure configured to contain at least one battery, comprising:
a primary base;
a first sidewall coupled to the primary base;
a second sidewall coupled to the primary base;
a top wall disposed on top of each of the first sidewall and the second sidewall, wherein the top wall is parallel to the primary base;
a back wall coupled to the primary base, wherein the back wall is perpendicular to the first sidewall and the second sidewall; and
a modular tray comprising:
a first base having a vertical flange disposed on a first side and a second side of the first base, wherein the first base is disposed on top of and aligned with the primary base;
a front wall coupled to the first base, wherein the front wall is perpendicular to the vertical flanges;
a first battery secured to the first base; and
a first set of barrier walls disposed between the first battery and the front wall, wherein the first set of barrier walls comprises:
a first barrier wall; and
a second barrier wall, wherein the first barrier wall is disposed between the first battery and the second barrier wall, wherein a first opening is defined between a top end of the first barrier wall and the top wall, wherein a second opening is defined between a bottom end of the second barrier wall and the first base,
wherein at least one of the first sidewall, the second sidewall, the first set of barrier walls, the back wall, the front wall, and the top wall comprises a fire-resistant material.

2. The modular tray enclosure of claim 1, further comprising a second set of barrier walls disposed between the first battery and the back wall, wherein each one of the first set of barrier walls and the second set of barrier walls comprises the first barrier wall and the second barrier wall, wherein both the first set of barrier walls and the second set of barrier walls comprise the fire-resistant material.

3. The modular tray enclosure of claim 1, further comprising a first pin extending from the first sidewall at least partially towards the second sidewall and a second pin extending from the second sidewall at least partially towards the first sidewall.

4. The modular tray enclosure of claim 3, wherein each of the vertical flanges comprises an opening configured to receive the first pin and the second pin, respectively.

5. The modular tray enclosure of claim 1, further comprising a protective housing disposed around at least a portion of the top wall, the first sidewall, the second sidewall, the primary base, or a combination thereof.

6. The modular tray enclosure of claim 1, further comprising a partition wall disposed between the first sidewall and the second sidewall, wherein the partition wall defines a first space configured to house the modular tray and a second space configured to house a second modular tray.

7. A battery cabinet, comprising:
a plurality of modular tray enclosures, wherein each one of the plurality of modular tray enclosures is configured as the modular tray enclosure of claim 1;
a plurality of modular trays housed in each of the plurality of modular tray enclosures, wherein each one of the plurality of modular trays is configured as the modular tray of claim 1; and
one or more busbars electrically connecting each one of the first batteries of the plurality of modular trays together.

8. A modular tray, comprising:
a first base having a vertical flange disposed on a first side and a second side of the first base, wherein each one of the vertical flanges comprises an opening configured to receive a pin;
a front wall coupled to the first base, wherein the front wall is perpendicular to the vertical flanges;
a first battery secured to the first base; and
a first set of barrier walls disposed between the first battery and the front wall, wherein the first set of barrier walls comprises:
a first barrier wall; and
a second barrier wall, wherein the first barrier wall is disposed between the first battery and the second barrier wall, wherein a first opening is defined between a bottom end of the second barrier wall and the first base.

9. The modular tray of claim 8, wherein the modular tray is configured to be housed in a modular tray enclosure, wherein the modular tray enclosure comprises:
a primary base;
a first sidewall coupled to the primary base;
a second sidewall coupled to the primary base;
a first pin extending from the first sidewall at least partially towards the second sidewall;
a second pin extending from the second sidewall at least partially towards the first sidewall;
a top wall disposed on top of each of the first sidewall and the second sidewall, wherein the top wall is parallel to the primary base; and
a back wall coupled to the primary base, wherein the back wall is perpendicular to the first sidewall and the second sidewall.

10. The modular tray of claim 9, wherein the vertical flange disposed on the first side of the first base is configured to receive the first pin.

11. The modular tray of claim 9, wherein the vertical flange disposed on the second side of the first base is configured to receive the second pin.

12. The modular tray of claim 8, wherein at least one of the first set of barrier walls and the front wall comprises a fire-resistant material.

13. The modular tray of claim 9, wherein at least one of the first sidewall, the second sidewall, the first set of barrier walls, the back wall, the front wall, and the top wall comprises a fire-resistant material.
